(19) United States
(12) Patent Application Publication
(10) Pub. No.: US 2011/0296099 A1
(43) Pub. Date: Dec. 1, 2011

(54) Access device and method for accelerating data storage and retrieval into and from storage device

(75) Inventors: Yu-Ting Chiu, Taipei City (TW); Chih-Liang Yen, Taipei City (TW); Cheng-Wei Yang, Taipei City (TW)

(73) Assignee: WareMax Electronics Corp., Taipei City (TW)

(21) Appl. No.: 13/067,128

(22) Filed: May 11, 2011

(30) Foreign Application Priority Data
May 26, 2010 (TW) 099116775

(51) Int. Cl. G06F 12/00

(52) U.S. Cl. 711/112; 711/E12.001

(57) ABSTRACT

The present invention is to provide an access device connected to a computer, a hard disk drive and a memory disk respectively, wherein the hard disk drive has a normal region divided into a plurality of regular sections, the memory disk is divided into a plurality of mirroring sections, and the access device stores an index table comprising a plurality of fields each having a flag. The access device can execute the steps of receiving a read instruction from the computer; reading sequentially the fields corresponding to the read instruction; reading data stored in a mirroring section corresponding to a field thus read and sending the data to the computer when the flag in the field is a first value; and reading data stored in a regular section corresponding to the field and sending the data to the computer when the flag in the field is a second value.

### FIELD OF THE INVENTION

The present invention relates to an access device for accelerating data storage and retrieval into and from a storage device, wherein the access device is connected to a computer, a hard disk drive (HDD) and a memory disk (e.g., a solid-state drive, or SSD) respectively, and is able to read data from the hard disk drive or the memory disk alternatively, according to flags in an index table, before sending the data to the computer. In addition, the access device is also able to mirror the data stored in the hard disk drive to the memory disk, according to the index table, so as to reduce the number of times for which the data have to be written into the memory disk, achieve the object of data synchronization between the hard disk drive and the memory disk, and in turn significantly increase data read speed.

### BACKGROUND OF THE INVENTION

A solid-state drive (SSD) is a digital data storage device based on non-volatile memory (e.g., a flash memory) and dispenses with the rotary disk (or platter) mechanism typical of a traditional hard disk drive (HDD). As solid-state drives are commonly used in portable electronic devices (e.g., laptop computers) as a substitute for hard disk drives, many people view solid-state drives as a different type of hard disk drives.

The SSD technology is distinguished from the HDD technology in that a solid-state drive does not rely on a magnetic read/write head to read and write data from and into spinning platters, but is composed of a plurality of memories (e.g., NAND memories) connected together and coupled with appropriate control chips and circuitry. Generally speaking, the memory for use in solid-state drives can be divided into two major categories: multi-level cell (MLC) and single-level cell (SLC). The recently developed triple-level cell (TLC) memory is also eligible but is disadvantaged by a smaller number of allowable erase/write cycles and shorter service lives. In terms of current technology, MLC-based solid-state drives are less costly than those based on SLC; however, the former has a lower write speed and a shorter service life. As for the connection interface between solid-state drives and computers, the SATA2 interface is currently the most popular, but some solid-state drives use other connection interfaces such as IDE, SATA, SATA3, 1394, USB, and PCI-E. When it comes to specifications, now that solid-state drives are often used to substitute for hard disk drives, solid-state drives are available in the same specifications as hard disk drives, i.e., with the form factor of 1.8, 2.5, or 3.5 inches. Nowadays, many companies are devoted to the manufacture and sale of solid-state drives; some notable examples are Intel Corporation, Samsung Electronics, and Hitachi Global Storage Technologies

In contrast to hard disk drives, which employ motor-driven platters, solid-state drives are advantageous in that they produce no noise, consume relatively low power, are highly resistant to shock during reading/writing, generate relatively low heat, and can be easily made lightweight; therefore, solid-state drives are perfect for use in portable electronic devices. Moreover, according to relevant assessment results, solid-state drives have read speeds approximately more than two to three times as high as those of hard disk drives and write speeds more than 1.5 times as high. Given that hard disk drives have become a bottleneck for system performance, solid-state drives are indeed a decent solution, but for the following drawbacks. First of all, the cost per megabyte of either non-volatile or volatile memory is presently far higher than that of a hard disc drive. As a result, the prices of high-capacity solid-state drives are so high that it is impossible for an ordinary user to replace all the hard disk drives in use with solid-state drives. More importantly, data are not directly written into the memory of a solid-state drive; a new entry of data cannot be written into the memory until the existing data are erased. Hence, there is an upper limit on the number of times for which data can be written into the memory of a solid-state drive. Furthermore, the write speed decreases with the number of times data have been written in to the memory. With the aforesaid drawbacks, the service lives of solid-state drives tend to be shorter than those of hard disk drives. When a user decides to replace all the hard disk drives in a personal computer with solid-state drives, the solid-state drives must take on a huge amount of data writing and therefore have reduced service lives. The user also has to take the risk of unexpected failure of the solid-state drives, which is extremely undesirable. Apart from that, once a solid-state drive is damaged, not only is the data stored therein likely to be lost, but also the user has to spend extra money to buy a new hard drive.

Then, the “hybrid drive” emerged. The hybrid drive, based on a technology generally known as HDDBOOST, involves a hard drive accelerator connected to both a hard disk drive and a solid-state drive and works on the following principle. In order to accelerate data access, the hard disk drive and the solid-state drive are combined to form a RAID 1 device, wherein data can be read from either drive and be simultaneously written into both. While this technology is effective in boosting data read speed to some degree, its data writing process leaves much to be desired. More particularly, the hard drive accelerator is configured to write data into the hard disk drive and the solid-state drive at the same time so as to achieve data synchronization therebetween, but this writing scheme still puts a heavy writing load on the solid-state drive and may cause the solid-state drive to die prematurely.

Therefore, the issue to be addressed by the present invention is to overcome the aforementioned problems and, by taking advantage of the high read speed of solid-state drives and precluding the need to write data into solid-state drives multiple times, increase the speed at which a computer can store and retrieve data into and from a storage device.

### BRIEF SUMMARY OF THE INVENTION

In view of the foregoing problems of the prior art, the inventor of the present invention conducted extensive research and experiment and finally succeeded in developing an access device and method for accelerating data storage and retrieval into and from a storage device as disclosed herein. The disclosed access device and method not only make use of the high read speed of a memory disk (e.g., solid-state drive) to increase the speed at which a computer can access data in a storage device, but also alleviate the writing load of the memory disk (e.g., solid-state drive) so as to increase the service life thereof.

It is an object of the present invention to provide an access device for accelerating data storage and retrieval into and from a storage device, wherein the access device includes a control module and a memory module. The control module is connected to a computer, a hard disk drive (HDD), and a memory disk (e.g., a solid-state drive, or SSD) respectively. The hard disk drive has a normal region where an operating system (OS) and other application programs are stored. In addition, the normal region is divided into a plurality of regular sections. The memory disk has a higher read speed than the hard disk drive and is divided into a plurality of mirroring sections which correspond to the regular sections respectively. The memory module is connected to the control module and stores an index table. The index table includes a plurality of fields corresponding respectively to the regular sections, and each field stores a flag. When the flag in a certain field is a first value (e.g., “0”), it means that the regular section corresponding to that field has the same contents as the corresponding mirroring section. However, when the flag in the field is a second value (e.g., “1”), it means that the contents stored in the regular section corresponding to the field are different from those stored in the corresponding mirroring section. When the computer attempts to read data from the hard disk drive, the control module receives a read instruction from the computer and reads the corresponding fields in the index table. Upon reading a field whose flag is the first value (meaning that the contents stored in the regular section corresponding to that field are consistent with those stored in the corresponding mirroring section), the control module chooses to read the data stored in the corresponding mirroring section (at a higher read speed than to read from the corresponding regular section) and then sends the data to the computer. However, when the flag in the field being read by the control module is the second value (meaning that the contents stored in the corresponding regular section and the corresponding mirroring section are inconsistent), the control module will read the data stored in the corresponding regular section (at a lower read speed than to read from the corresponding mirroring section), before sending the data to the computer. Thus, when the computer reads data through the control module, the control module allows the computer to read all or part of the data from the memory disk, whose read speed is higher than the hard disk drive, thereby significantly increasing data read speed.

It is another object of the present invention to provide the foregoing access device, wherein when the computer attempts to write data into the hard disk drive, the control module receives a write instruction from the computer, performs a data writing process on the hard disk drive accordingly, and after the data writing process is completed to thereby alter the data stored in any regular section, sets the flag in the field corresponding to that regular section to the second value. Thus, the control module is configured to write data into the hard disk drive first, with a view to increasing the service life of the memory disk by reducing the number of times for which data have to be written into the memory disk.

It is yet another object of the present invention to provide the foregoing access device, wherein upon receiving a drive instruction from the computer or when the user presses a key on the access device, the control module begins to read the fields of the index table sequentially. Whenever the flag of a field thus read is the second value, the control module copies the data stored in the regular section corresponding to the field to the mirroring section corresponding to the field and changes the flag in the field to the first value, thus completing data mirroring between the corresponding regular section and mirroring section. By so doing, not only is the number of times for which data have to be written into the memory disk reduced, but also data synchronization between the regular sections and the mirroring sections is achieved to increase data read speed. In addition, while the control module performs data mirroring, it still can receive read instructions from the computer, read data in the aforesaid manner, and send the read data to the computer.

Still another object of the present invention is to provide an access method for accelerating data storage and retrieval into and from a storage device. The access method is applicable to an access device, wherein the access device is connected to a computer, a hard disk drive, and a memory disk respectively. The hard disk drive has a normal region divided into a plurality of regular sections. The memory disk is divided into a plurality of mirroring sections. The access device stores an index table which includes a plurality of fields, and each field stores a flag. Upon receiving a read instruction from the computer, the control module sequentially reads the fields corresponding to the read instruction. When the flag of a field thus read is a first value, the control module reads the data stored in the mirroring section corresponding to that field and sends the data to the computer. However, when the flag of the field is a second value, the control module reads the data stored in the corresponding regular section and sends the data to the computer.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a block diagram of an embodiment of the present invention;

FIG. 2 shows an index table according to the present invention;

FIG. 3 is a flowchart for matching a memory disk with a hard disk drive for the first time;

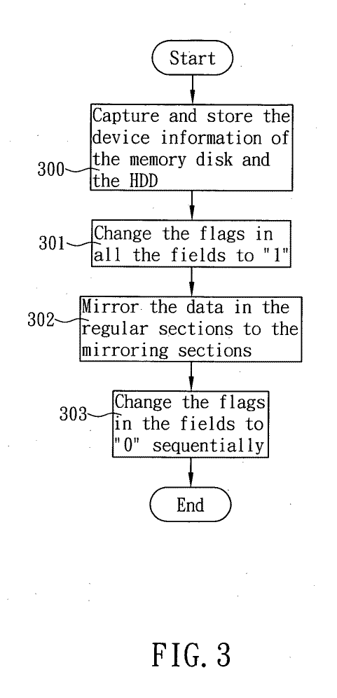

FIG. 4 is a block diagram showing the memory disk and the hard disk drive upon completion of the first data mirroring;

FIG. 5 shows the index table after completion of the first data mirroring;

FIG. 6 is a flowchart for a data reading process of a computer by way of a control module;

FIG. 7 is a block diagram showing the memory disk and the hard disk drive after the computer writes data into the hard disk drive by way of the control module;

FIG. 8 is a flowchart for a data writing process of the computer by way of the control module;

FIG. 9 shows the index table after the data writing process;

FIG. 10 is a flowchart for a data mirroring process;

FIG. 11 is a block diagram showing the memory disk and the hard disk drive upon completion of the data mirroring process;

FIG. 12 is another flowchart for the data mirroring process; and

FIG. 13 is a block diagram of another hardware composition of the present invention.

### DETAILED DESCRIPTION OF THE INVENTION

A solid-state drive—or more specifically a “memory device composed of a memory and a control chip”—is also known in Japan as a “memory disk”. Therefore, the term “memory disk” is used in the present application to refer to all such drives. In other words, the term “memory disk” as used herein refers to a “memory device composed of a memory and a control chip”.

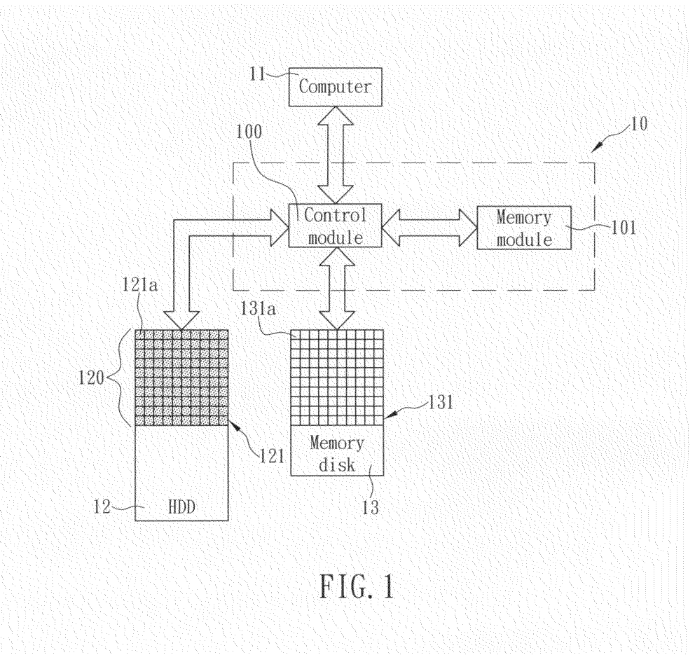

In a preferred embodiment of the present invention as shown in FIG. 1, an access device 10 for accelerating data storage and retrieval into and from a storage device includes a control module 100 and a memory module 101. The control module 100 is connected to a computer 11, a hard disk drive 12, and a memory disk 13 respectively. The control module 100 is connected to the computer 11 through a connection interface of the access device 10, wherein the connection interface can be the IDE, SATA, SATA2, SATA3, 1394, USB, or PCI-E interface. Similarly, the connection interface between the access device 10 and the hard disk drive 12 and between the access device 10 and the memory disk 13 can be designed according to practical needs as the IDE, SATA, SATA2, or SATA3 interface. The memory disk 13 has a higher read speed than the hard disk drive 12. The hard disk drive 12 has a normal region 120 where an operating system (OS) is stored. The operating system can be Windows XP, Windows Vista, Linux, or BSD, to name only a few examples. In addition, the operating system is installed with application programs such as document preparation programs, web browsers, and graphics software. In Windows XP, the normal region 120 can be designated as Drive C (C:\) but is not limited thereto. The normal region 120 can also be designated by other paths. Alternatively, the normal region 120 may include the entire Drive C plus a part of or the entire Drive D or even include several contiguous or discrete hard drive partitions. In Linux or BSD, the path assigned to the normal region 120 may vary in many ways, too. Therefore, the designation or path of the normal region 120 is not limited to those mentioned above. The normal region 120 has a capacity of 5,000 MB (megabyte) and is divided into 100 regular sections 121, each regular section 121 having a capacity of 50 MB. It is understood, however, that the aforesaid capacities and the aforesaid number of the regular sections 121 are only a preferred embodiment and should not be construed as restrictive of the present invention. Likewise, the memory disk 13 is divided into 100 mirroring sections 131, and each mirroring section 131 has a capacity of 50 MB. The mirroring sections 131 correspond respectively to the regular sections 121. For example, referring to FIG. 1, the mirroring section 131a in the first column of the first row (i.e., the one in the upper left corner) corresponds to the regular section 121a in the first column of the first row (i.e., the one in the upper left corner), and the rest can be known by analogy.

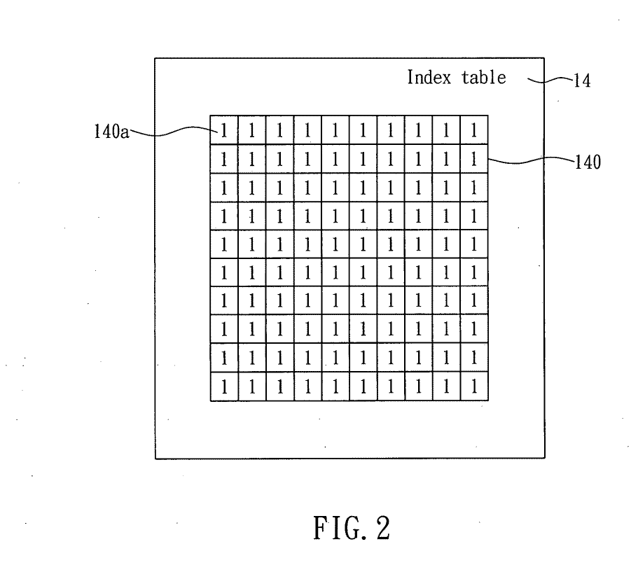

In the preferred embodiment described above, referring to FIGS. 1 and 2, the memory module 101 is connected to the control module 100 and stores an index table 14. The index table 14 includes 100 fields 140, and each field 140 stores a flag (either “0” or “1”). The fields 140 correspond respectively to the regular sections 121 and hence to the mirroring sections 131. For example, the field 140a in the first column of the first row corresponds to the regular section 121a in the first column of the first row, and the rest can be deduced by analogy. When the access device 10 is connected to the computer 11, and the memory disk 13 (with no data stored therein) and the hard disk drive 12 are connected to the access device 10 for the first time, the control module 100 performs an initialization process as follows:

(300) The control module 100 captures the device information (e.g., product serial numbers, manufacturers' names, etc.) of the memory disk 13 and the hard disk drive 12 and stores the device information into the memory module 101.

(301) The control module 100 changes the flags in all the fields 140 of the index table 14 to “1”, as shown in FIG. 2.

(302) The control module 100 sequentially mirrors (i.e., copies) the data stored in the regular sections 121 to the mirroring sections 131.

(303) Whenever the data in a regular section 121 is mirrored to the corresponding mirroring section 131, the control module 100 changes to “0” the flag in the field 140 of the index table 14 that corresponds to that regular section 121.

With the device information of the memory disk 13 and the hard disk drive 12 being stored into the memory module 101 in step (300), the control module 100 can recognize the memory disk 13 and the hard disk drive 12 when the computer 11 is turned on at a later time and identify both the memory disk 13 and the hard disk drive 12 as having been initialized. Therefore, it is not necessary to mirror (i.e., copy) all the data in the hard disk drive 12 to the memory disk 13 each time the computer 11 is turned on.

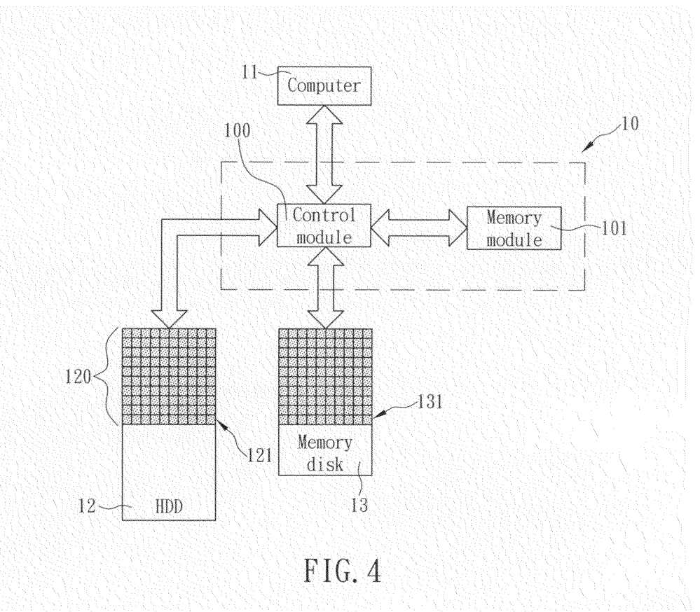

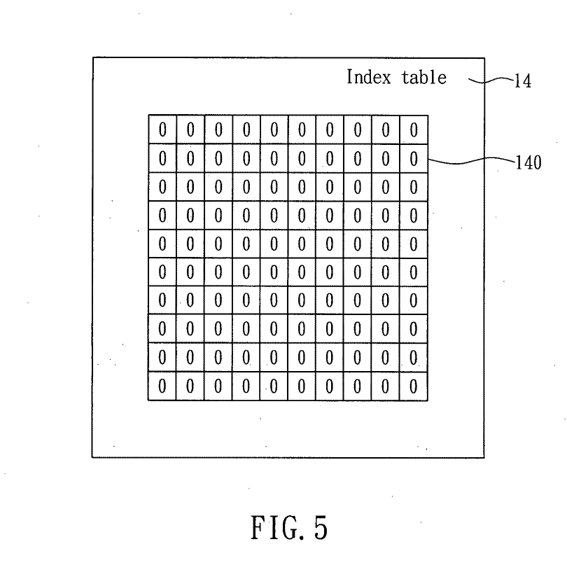

Referring to FIG. 4, once the control module 100 mirrors the data stored in all the regular sections 121 entirely to the mirroring sections 131, the data in the memory disk 13 are identical to the data in the normal region 120. Also, as shown in FIG. 5, the flags in all the fields 140 of the index table 14 have been changed to “0”, meaning that the data stored in the regular sections 121 are consistent with those stored in the corresponding mirroring sections 131. It should be noted that the access device 10 can be so designed that step (301) is omitted, provided that the control module 100 is configured to mirror the data in all the regular sections 121 to the mirroring sections 131 and set the flags in all the fields 140 to “0” upon determining that, according to the device information stored in the memory module 101, the hard disk drive 12 and the memory disk 13 are matched for the first time. In the present preferred embodiment, when the flag of a certain field 140 is a first value “0”, the regular section 121 corresponding to that field 140 has the same contents as the corresponding mirroring section 131; and when the flag of the field 140 is a second value “1”, the contents stored in the regular section 121 corresponding to the field 140 are different from those stored in the corresponding mirroring section 131. However, the contents of the flags are not limited to the aforesaid values (i.e., “0” and “1”) and may include variations which are easily conceivable by a person skilled in the art.

Referring to FIG. 4, the regular sections 121 are sequentially defined, in the order from left to right and top to bottom, as a first regular section, a second regular section, a third regular section, and so on. Similarly, the mirroring sections 131 are sequentially defined in the same order as a first mirroring section, a second mirroring section, a third mirroring section, and so on. The fields 140 of the index table 14 as shown in FIG. 5 are also sequentially defined in the same order as a first field, a second field, a third field, and so on.

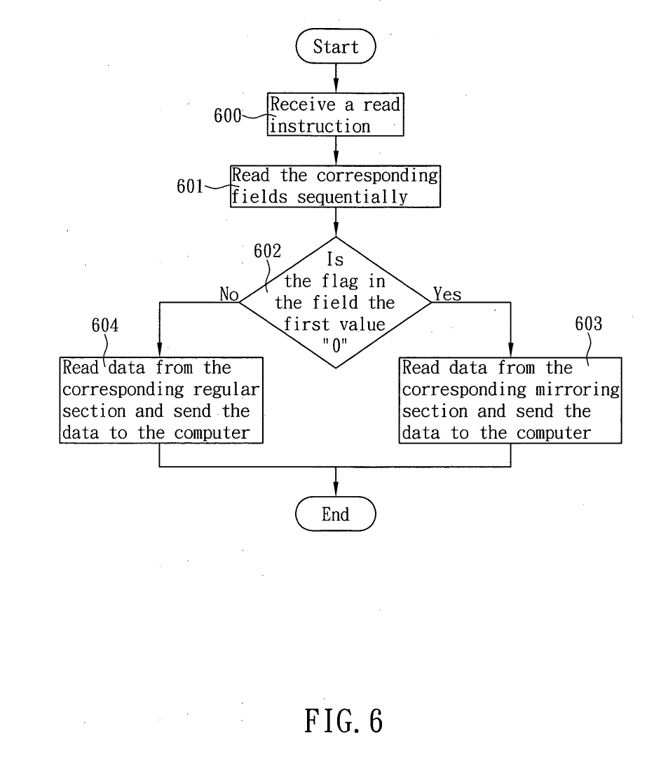

After steps (300) to (303), the data stored in the mirroring sections 131 are consistent with those in the corresponding regular sections 121. If in this state the computer 11 attempts to read the data in the first through fifth regular sections (the first through fifth mirroring sections), the control module 100 will perform the following steps (see FIG. 6 in conjunction with FIGS. 4 and 5) in order to send the data to the computer 11:

(600) The control module 100 receives a read instruction from the computer 11.

(601) The control module 100 sequentially reads the first through fifth fields of the index table 14.

(602) The control module 100 determines whether the flag in the field 140 being read is the first value “0”. If yes, go on to step (603); otherwise, go to step (604).

(603) The control module 100 reads the data stored in the mirroring section 131 corresponding to the aforesaid field 140 and sends the data to the computer 11.

(604) The control module 100 reads the data stored in the regular section 121 corresponding to the aforesaid field 140 and sends the data to the computer 11.

Referring to FIGS. 4 and 5, now that the flags in all the fields 140 are the first value “0”, the control module 100 during the foregoing process only reads data from the first through fifth mirroring sections 131 of the memory disk 13 before sending the data to the computer 11. Thus, the computer 11 obtains all the desired data from the memory disk 13. As the memory disk 13 has a higher read speed than the hard disk drive 12, the technical features of the present invention substantially increase data read speed.

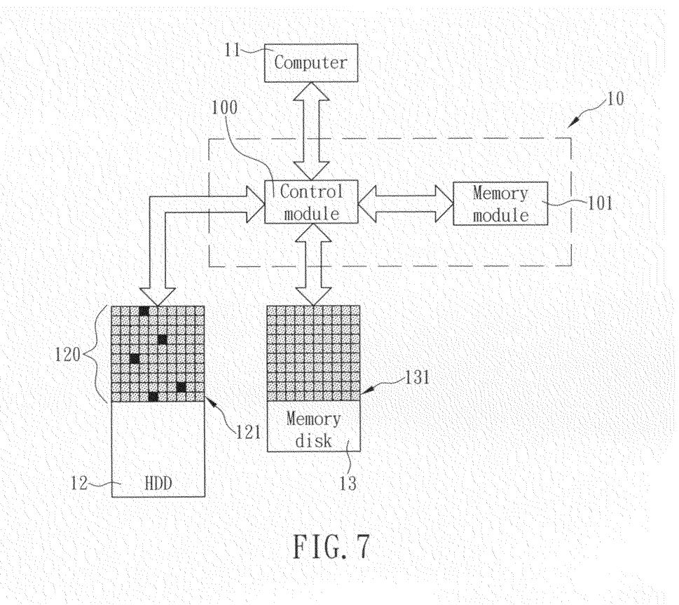

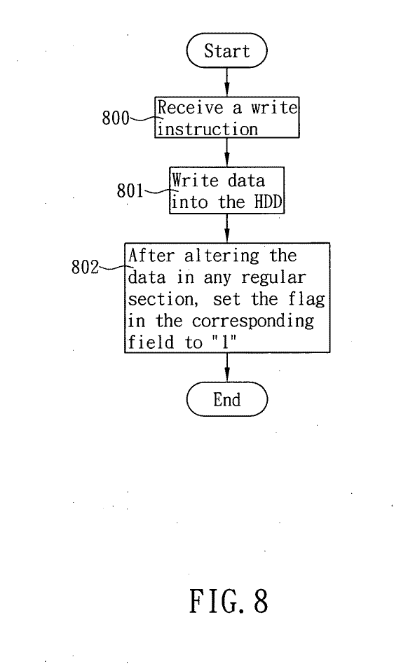

As to the data writing process, a detailed description is given below with reference to FIGS. 7 to 9. When the computer 11 attempts data writing, the control module 100 performs the following steps to carry out the data writing process:

(800) The control module 100 receives a write instruction from the computer 11.

(801) The control module 100 writes data into the hard disk drive 12. In the present preferred embodiment, the data are written into the 4th regular section, the 36th regular section, the 53rd regular section, the 88th regular section, and the 95th regular section (as indicated by the black cells in FIG. 7) respectively.

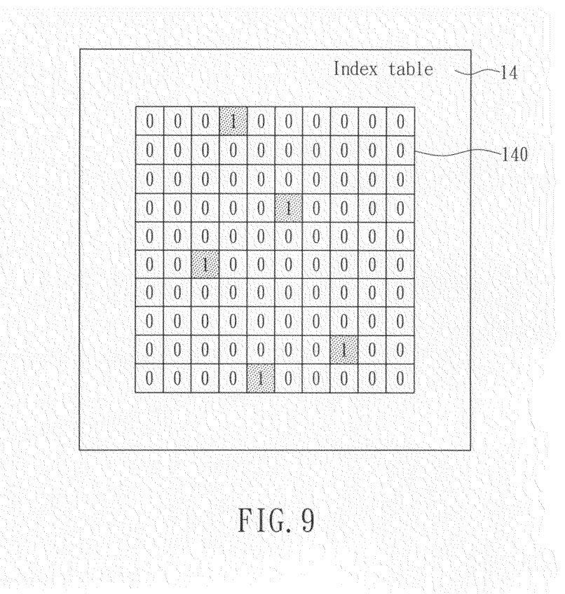

(802) After altering the data in any regular section 121, the control module 100 sets the flag in the field 140 corresponding to that regular section 121 to the second value “1” (as shown in FIG. 9).

With reference to FIG. 7 and FIG. 9, once the control module 100 writes the data into the 4th, 36th, 53rd, 88th, and 95th regular sections of the hard disk drive 12, the flags in the 4th, 36th, 53rd, 88th, and 95th fields of the index table 14 are changed to “1”, meaning that the contents of the afore-cited regular sections 121 are different from those in the corresponding mirroring sections 131. Referring again to FIGS. 7 and 9, if in this state the computer 11 attempts to read data from the first to fifth regular sections (mirroring sections), the control module 100 still follows steps (600) through (604) in FIG. 6 to complete the data reading process. As the flags in the first to third fields of the index table 14 are now “0” (see FIG. 9), the control module 100 will read the data stored in the first to third mirroring sections of the memory disk 13 and send the data to the computer 11. When the control module 100 afterward reads the flag in the fourth field of the index table 14, which is “1” (see FIG. 9), the control module 100 will read the data in the fourth regular section of the hard disk drive 12 and send the data to the computer 11. Then, the control module 100 reads the data stored in the fifth mirroring section of the memory disk 13 and send the data to the computer 11. By virtue of the foregoing technical features, the computer 11 obtains most of the data from the memory disk 13 and therefore maintains high data read speed. Furthermore, even if the computer 11 has written data into the hard disk drive 12 and thereby altered some of the data in the normal region 120 of the hard disk drive 12, the high data read speed can still be kept because, while the computer 11 attempts to read data through the control module 100, only those data that are altered (recently written) are read from the normal region 120. The rest of the data, which are intact, are still read from the memory disk 13.

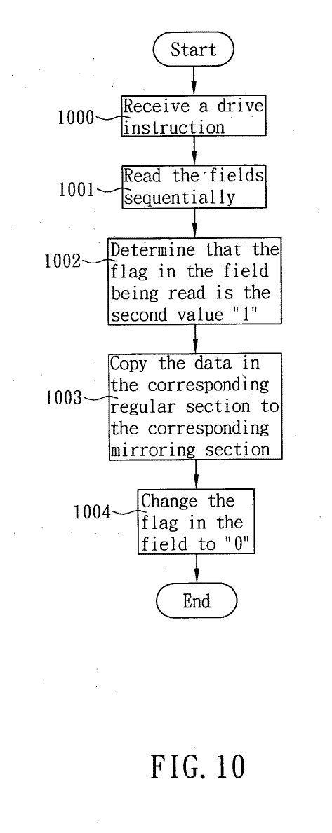

However, after the computer 11 has been operated for some time, the data writing process may have been performed on the hard disk drive 12 for so many times that there are too many non-synchronized sections in the normal region 120 of the hard disk drive 12 and the memory disk 13 (i.e., there is a huge difference in contents between the hard disk drive 12 and the memory disk 13). If the computer 11 attempts to read data under such circumstances, most of the data will be read from the normal region 120 of the hard disk drive 12, and only a small portion of the data will be read from the memory disk 13. As a result, the overall read speed is lowered to approximately the read speed of the hard disk drive 12, for the high read speed of the memory disk 13 is not taken full advantage of. To avoid such a scenario, the access device 10 must perform a data mirroring process to synchronize the data in the memory disk 13 and the normal region 120. According to the present invention, the control module 100 is so configured that, when the computer 11 is turned on (or off), the control module 100 receives a drive instruction from the computer 11 and performs the data mirroring process accordingly. Referring to FIGS. 7, 9, and 10, the control module 100 synchronizes the data in the memory disk 13 and the normal region 120 through the following steps:

(1000) The control module 11 receives the drive instruction from the computer 11.

(1001) The control module 11 reads the fields 140 sequentially.

(1002) The control module 11 determines that the flag in the field 140 being read is the second value “1”. Go on to step (1003).

(1003) The control module 11 copies the data stored in the regular section 121 corresponding to the aforesaid field 140 to the mirroring section 131 corresponding to that field 140.

(1004) The control module 11 changes the flag in the aforesaid field 140 to the first value “0”.

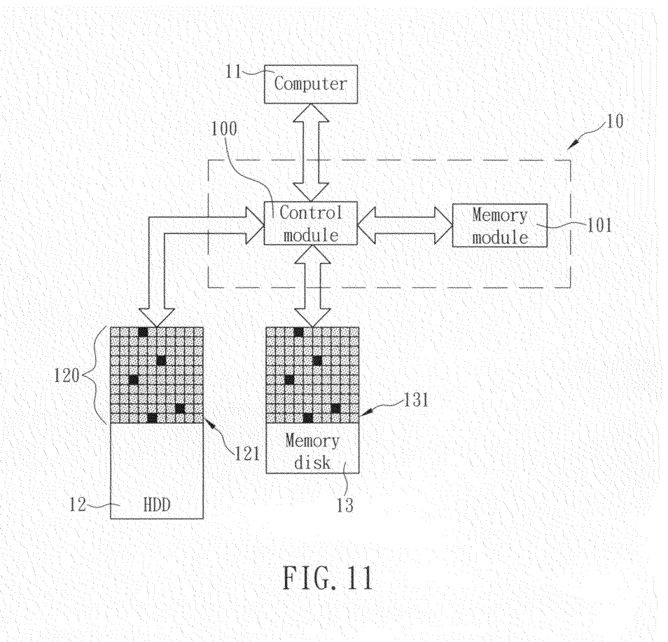

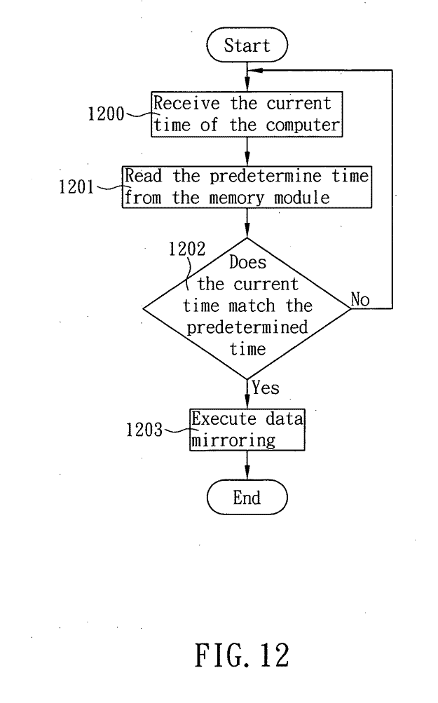

In steps (1000) to (1004), given that the flags in the 4th, 36th, 53rd, 88th, and 95th fields of the index table 14 are “1” as shown in FIG. 9, the control module 100 upon receiving the drive instruction mirrors (i.e., copies) the data stored in the 4th, 36th, 53rd, 88th, and 95th regular sections of the hard disk drive 12 (i.e., the black cells in FIG. 7) to the 4th, 36th, 53rd, 88th, and 95th mirroring sections 131 of the memory disk 13 respectively, as shown in FIG. 11. Consequently, the data stored in the afore-cited mirroring sections 131 and the corresponding regular sections 121 are consistent. Moreover, when the data mirroring process is completed, the flags in all the fields 140 of the index table 14 are “0”, as shown in FIG. 5. It is worth mentioning that an application program can be designed for the present invention whereby a user can instruct the computer 11 to send the drive instruction to the control module 100 so that the control module 100 begins data mirroring. Alternatively, the access device 10 can be provided with a key or other hardware device, and the control module 100 starts the data mirroring process as soon as the key is pressed. In addition, referring to FIGS. 7 and 12, it is also feasible in this preferred embodiment to set (store) a predetermine time into the memory module 101 so that, by means of task scheduling, the control module 100 executes data mirroring according to the following steps:

(1200) The control module 100 receives the current time of the computer 11.

(1201) The control module 100 reads the predetermined time preset in the memory module 101.

(1202) The control module 100 compares the current time with the predetermined time. If a match is found, go on to step (1203); otherwise, go back to step (1200).

(1203) The control module 100 executes the data mirroring process (i.e., step (1001) to step (1004)).

The technical features of steps (1200) to (1203) allow the user to preset a predetermined time into the memory module 101 by way of an application program according to practical needs or the user's habits of use of the computer 11. Thus, when the predetermined time comes, the control module 100 begins data mirroring to synchronize the data in the memory disk 13 and the normal region 120 and thereby maintain a high data read speed. Besides, the access device 10 can be so designed that the data mirroring process is triggered otherwise. For example, the memory module 101 is pre-stored with a predetermined ratio (e.g., 30% or 50%), and the control module 100 performs the data mirroring process (i.e., the foregoing steps (1001) to (1004)) immediately when the number of fields 140 whose flags have been changed to “1” reaches 30 (or 50) (i.e., when the ratio of the number of fields 140 with the flag of “1” to the total number of fields 140 in the index table 14 reaches the predetermined ratio) as the access device 10 reads the fields 140 sequentially.

According to the present invention, when the computer 11 reads data through the control module 100, all or part of the data will be read from the memory disk 13, whose read speed is relatively high. When the computer 11 performs the data writing process through the control module 100, the control module 100 is configured to write data into the hard disk drive 12 first (see FIG. 7). The control module 100 will not mirror the data in the hard disk drive 12 to the memory disk 13 (see FIG. 11) until the computer 11 is turned on again or turned off, or until a predetermined time comes, or unless according to the user's setting. The technical features described above not only substantially increase data read speed, but also effectively reduce the number of times data have to be written into the memory disk 13, thereby increasing the service life of the memory disk 13. Besides, the access device 10 requires no complicated installing procedures; all that needs to be done is to connect the access device 10 to the computer 11 and then connect the hard disk drive 12 and the memory disk 13 to the device 10. Hence, the access device 10 is convenient to use.

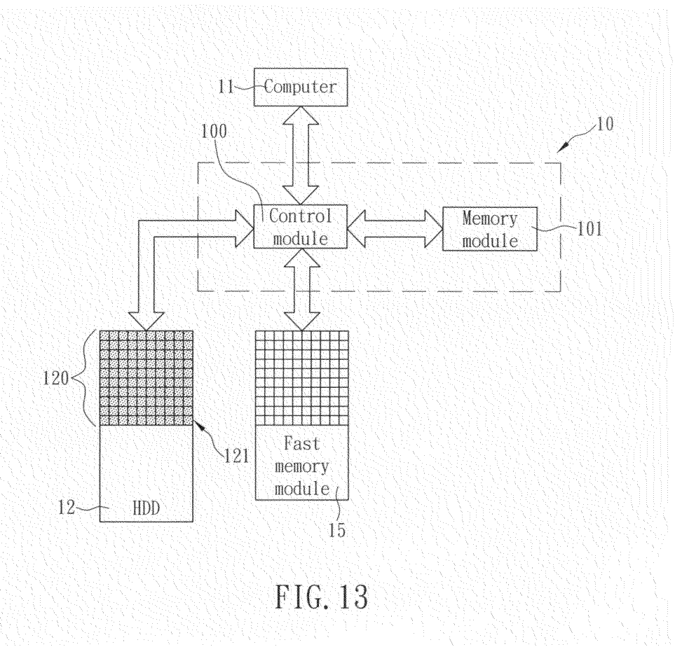

The foregoing embodiments are only the preferred ones and are not intended to restrict the technical features of the present invention. A person skilled in the art who has reviewed the technical contents disclosed herein may modify the hardware composition of the present invention without departing from the spirit of the present invention. For instance, referring to FIG. 13, a fast memory module 15 (e.g., a flash memory) is used in place of the previously described memory disk and is directly connected to the access device 10. Also, the functions of the control chip of a solid-state drive can be incorporated into the disclosed control module 100 to attain the objects of the present invention. Therefore, all changes or modifications which are easily conceivable by a person skilled in the art should fall within the scope of the present invention as set forth in the appended claims.

What is claimed is:

1. An access device for accelerating data storage and retrieval into and from a storage device, the access device being connected to a computer, a hard disk drive, and a memory disk respectively, the hard disk drive having a normal region, the normal region being divided into a plurality of regular sections, the memory disk having a higher read speed than the hard disk drive and being divided into a plurality of mirroring sections corresponding respectively to the regular sections, the access device comprising:
a memory module storing an index table, the index table comprising a plurality of fields corresponding respectively to the regular sections, each said field storing a flag; and
a control module connected to the memory module and configured to read, upon receiving a read instruction from the computer, said fields corresponding to the read instruction, wherein when the flag in a said field thus read is a first value, the control module reads data stored in the mirroring section corresponding to the field and sends the data to the computer, and when the flag in the field is a second value, the control module reads data stored in the regular section corresponding to the field and sends the data to the computer.

2. The access device of claim 1, wherein upon receiving a write instruction from the computer, the control module writes data into the hard disk drive and, after changing data stored in any said regular section, the control module sets the flag in the field corresponding to the regular section to the second value.

3. The access device of claim 1, wherein in an attempt to perform data mirroring, the control module reads the fields sequentially and, when the flag in a said field thus read is the second value, the control module copies data stored in the regular section corresponding to the field to the mirroring section corresponding to the field and changes the flag in the field to the first value.

4. The access device of claim 2, wherein in an attempt to perform data mirroring, the control module reads the fields sequentially and, when the flag in a said field thus read is the second value, the control module copies data stored in the regular section corresponding to the field to the mirroring section corresponding to the field and changes the flag in the field to the first value.

5. The access device of claim 1, wherein the memory module stores a predetermined time, the control module reading the fields sequentially upon determining that a current time of the computer matches the predetermined time, and when the flag in a said field thus read is the second value, the control module copies data stored in the regular section corresponding to the field to the mirroring section corresponding to the field and changes the flag in the field to the first value.

6. The access device of claim 2, wherein the memory module stores a predetermined time, the control module reading the fields sequentially upon determining that a current time of the computer matches the predetermined time, and when the flag in a said field thus read is the second value, the control module copies data stored in the regular section corresponding to the field to the mirroring section corresponding to the field and changes the flag in the field to the first value.

7. The access device of claim 1, wherein the memory module stores a predetermined ratio, the control module reading the fields sequentially when a ratio of the number of said fields whose said flags have been changed to the second value to a total number of the fields of the index table reaches the predetermined ratio, and when the flag of a said field thus read is the second value, the control module copies data stored in the regular section corresponding to the field to the mirroring section corresponding to the field and changes the flag in the field to the first value.

8. The access device of claim 2, wherein the memory module stores a predetermined ratio, the control module reading the fields sequentially when a ratio of the number of said fields whose said flags have been changed to the second value to a total number of the fields of the index table reaches the predetermined ratio, and when the flag of a said field thus read is the second value, the control module copies data stored in the regular section corresponding to the field to the mirroring section corresponding to the field and changes the flag in the field to the first value.

9. An access method for accelerating data storage and retrieval into and from a storage device, the access method being applicable to an access device, the access device being connected to a computer, a hard disk drive, and a memory disk respectively, the hard disk drive having a normal region, the normal region being divided into a plurality of regular sections, the memory disk being divided into a plurality of mirroring sections, the access device storing an index table, the index table comprising a plurality of fields, each said field storing a flag, the access method comprising the steps, performed by the access device in order to carry out a data reading process, of:
receiving a read instruction from the computer;
reading sequentially said fields corresponding to the read instruction;
reading data stored in a said mirroring section corresponding to a said field thus read, and sending the data to the computer, when the flag in the field is a first value; and
reading data stored in a said regular section corresponding to the field, and sending the data to the computer, when the flag in the field is a second value.

10. The access method of claim 9, further comprising the steps, performed by the access device in order to carry out a data writing process, of:
receiving a write instruction from the computer;
writing data into the hard disk drive according to the write instruction; and
setting, upon changing data stored in any said regular section, the flag in a said field corresponding to the regular section to the second value.

11. The access method of claim 9, further comprising the steps, performed by the access device in order to carry out a data mirroring process, of:
reading the fields sequentially; and
copying data stored in a said regular section corresponding to a said field thus read to a said mirroring section corresponding to the field, and changing the flag in the field to the first value, when the flag in the field is the second value.

12. The access method of claim 10, further comprising the steps, performed by the access device in order to carry out a data mirroring process, of:
reading the fields sequentially; and
copying data stored in a said regular section corresponding to a said field thus read to a said mirroring section corresponding to the field, and changing the flag in the field to the first value, when the flag in the field is the second value.

13. The access method of claim 9, wherein the access device stores a predetermined time, and the method further comprises the steps, performed by the access device in order to carry out a data mirroring process, of:
receiving a current time of the computer;
reading the predetermined time from the access device;
comparing the current time with the predetermined time;
determining that the current time matches the predetermined time;
reading the fields sequentially; and
copying data stored in a said regular section corresponding to a said field thus read to a said mirroring section corresponding to the field, and changing the flag in the field to the first value, when the flag in the field is the second value.

14. The access method of claim 10, wherein the access device stores a predetermined time, and the method further comprises the steps, performed by the access device in order to carry out a data mirroring process, of:
receiving a current time of the computer;
reading the predetermined time from the access device;
comparing the current time with the predetermined time;
determining that the current time matches the predetermined time;
reading the fields sequentially; and
copying data stored in a said regular section corresponding to a said field thus read to a said mirroring section corresponding to the field, and changing the flag in the field to the first value, when the flag in the field is the second value.

15. The access method of claim 9, wherein the access device stores a predetermined ratio, and the method further comprises the steps, performed by the access device in order to carry out a data mirroring process, of:
reading the fields;
determining that a ratio of the number of said fields whose said flags have been changed to the second value to a total number of the fields of the index table reaches the predetermined ratio;
reading the fields sequentially; and
copying data stored in a said regular section corresponding to a said field thus read to a said mirroring section corresponding to the field, and changing the flag in the field to the first value, when the flag in the field is the second value.

16. The access method of claim 10, wherein the access device stores a predetermined ratio, and the method further comprises the steps, performed by the access device in order to carry out a data mirroring process, of:
reading the fields;
determining that a ratio of the number of said fields whose said flags have been changed to the second value to a total number of the fields of the index table reaches the predetermined ratio;
reading the fields sequentially; and
copying data stored in a said regular section corresponding to a said field thus read to a said mirroring section corresponding to the field, and changing the flag in the field to the first value, when the flag in the field is the second value.
